(19) United States
(12) Patent Application Publication
(10) Pub. No.: US 2014/0240709 A1
(43) Pub. Date: Aug. 28, 2014

(54) ADVANCED MASS GAUGE SENSOR

(71) Applicant: Russell L. Case, JR., Oviedo, FL (US)

(72) Inventor: Russell L. Case, JR., Oviedo, FL (US)

(21) Appl. No.: 14/188,129

(22) Filed: Feb. 24, 2014

Related U.S. Application Data
(60) Provisional application No. 61/769,390, filed on Feb. 26, 2013.

(51) Int. Cl. G01N 21/59

(52) U.S. Cl. CPC G01N 21/59
USPC 356/436

(57) ABSTRACT

An advanced mass gauge sensor is disclosed comprising a vessel having an interior surface which reflects radiant energy at wavelengths at least partially absorbed by a fluid or fluids contained within the vessel, an illuminating device or devices for introducing radiant energy at such wavelengths into the vessel interior, and detectors for measuring the energy per unit area of illumination within the vessel created by the radiant energy which is not absorbed by the fluid or fluids.

### FIELD OF THE INVENTION

This application claims priority to U.S. Application Ser. No. 61/769,390 filed on Feb. 26, 2013, the contents of which are fully incorporated herein by reference.

### BACKGROUND OF THE INVENTION

Fluids such as liquid hydrogen, liquid oxygen, liquid methane, hydrazine, liquid natural gas, kerosene, and others are used in applications such as the propulsion of vehicles, including spacecraft operating in zero or micro-gravity conditions. At the end of their missions spacecraft must preserve adequate propellant to safely exit their orbit (de-orbit) into an atmospheric re-entry, a higher disposal orbit, or be forced into a safe trajectory. Increased accuracy of just a few percent in fluid inventories can represent millions of dollars in additional revenues or cost savings over the life of a spacecraft and the lives of crew members in manned missions.

In order to manage fluid inventories, a number of methods and technologies have been used. The primary method is bookkeeping. The total amount of a fluid is known and an estimate of the amount of fluid used for various activities is simply subtracted from the total. Because this method involves estimating fluid consumption, it is inherently inaccurate. Other methods include capacitive, resistive, ultrasonic (acoustic), radiation attenuation, mechanical compression, and radio frequency resonance. These methods require the spacecraft to be accelerating, rotating, the measured liquid to be in contact with the sensor, or are inherently inaccurate. Some methods require complex electromechanical or intrusive instrumentation. Additionally, fluids in zero or micro-gravity conditions are not stationary relative to a fixed measurement reference. They can contact one or more surfaces within the storage vessel, maintain multiple states (liquid and gaseous), and can be in contact with no surface at all.

An improvement over the existing technologies is found in U.S. Pat. No. 6,118,134, which is an optical mass gauge sensor comprising a vessel having an interior surface which reflects radiant energy at a wavelength at least partially absorbed by a fluid contained within the vessel, an illuminating device for introducing radiant energy at such wavelength into the vessel interior, and, a detector for measuring the energy per unit area of illumination within the vessel created by the radiant energy which is not absorbed by the fluid. In this patent two concepts are merged to form this improvement—the integrating sphere and Beer's law (Beer-Lambert law).

### Beer's Law

Beer's law describes the dependence between the transmissivity of light through a substance, the distance light travels through a substance, and the absorption coefficient of a substance. For this dependence to be valid, the radiation must not influence the atoms or molecules of the substance or substances (optical pumping or saturation), the incident radiation must be parallel (each ray traversing the same distance through the medium), the spectrum of the incident radiation must be narrower than the absorbing transition of the fluid, the fluid cannot scatter the incident radiation, the fluid must be homogeneous, and in the case of multiple fluids, the absorption spectra must be independent. If there are any deviations from these conditions, there will be consequential deviations in the results derived from Beer's law and the integrating sphere.

### Integrating Spheres

An integrating sphere (Ulbrecht sphere) utilizes the property of uniform diffuse reflection to eliminate any spatial information while preserving power (spatial integration of radiant flux). In order for the integrating sphere to perform adequately, the interior surface must be reflective with a Lambertian profile (cosine emission law) and the orientation of the emitter and detector must not be coaxially opposing or directly reflective. The efficiency of the sphere is dependent on the efficiency of the surface reflectivity as well as sphere size, surface uniformity, number of ports and their relative surface area, screens, baffles, inclusions within the sphere, uniformity of the reflective surface, and other factors. A port to surface area ratio greater than about 5% can significantly alter the radiation flux and invalidate the theoretical values. Generally integrating spheres are specifically designed and purpose built for an application.

### Liquid Vessels

Liquid Vessels, or tanks, used in vehicles and spacecraft are generally not designed to be used as an integrating sphere. Many tank geometries are non-spherical or represent complex shapes. Some include diaphragms connected mid-plane in order to force fluids to the expulsion port. Most tanks used for propellants contain vanes that act as propellant management devices (PMDs) and take advantage of the surface tension of the propellant to migrate the liquid to the expulsion port. Other internal features include sponges, baffles, vanes, anti-slosh devices, anti-vortex devices, fuel traps, inlet ports, outlet ports, perforated sheets, screens, and manufacturing features such as weld lines. These PMDs and internal features can account for surface areas in excess of 50% of the internal surface area of the tank.

There is a need for an advanced mass gauge that is able to operate under zero or micro-gravity conditions, performs at all reasonable vehicle operating modes, functions across all reasonable environments of pressure and temperature, minimizes tank invasiveness, is compact, performs with greater accuracy, provides virtually instantaneous measurements, minimizes vehicle resource impact, has enhanced manufacturability, and reduces the errors inherent with the existing system.

### SUMMARY OF THE INVENTION

It is therefore among the objectives of this invention to provide a method and apparatus for measuring the quantity of fluid within a storage vessel which is capable of operating under zero gravity conditions, which is effective to sense the quantity of cryogenic and other types of liquid and gaseous fluids, which is capable of sensing the quantities of different types of fluids within the same vessel, which can be retrofitted to existing vessels, and, which is highly accurate.

These objectives are accomplished in a method and apparatus according to this invention which comprises a vessel having an interior surface which reflects radiant energy at a wavelength absorbed by the fluid contained within the vessel, an illuminating device for introducing radiant energy at such wavelength into the vessel interior, and, a detector for sensing the radiant energy within the vessel interior which is not absorbed by the fluid and measuring the energy per unit area of illumination.

This invention is predicated on the concept that the amount of radiant energy of a particular wavelength which is absorbed by a fluid present within the interior of a vessel is proportional to the quantity of fluid in the vessel. In the presently preferred embodiment, a closed vessel in the shape of a sphere, cylinder, or the like is provided with an illuminating device operative to direct radiant energy into the vessel interior, and photo-detectors capable of measuring the energy per unit area of illumination (watts/cm²) created by the radiant energy which is not absorbed by the fluid within the vessel. The photo-detectors produce signals having a component representative of the energy per unit area of illumination, which is compared with predetermined or known fluid quantities within that vessel to obtain the actual or sensed fluid level.

Operation of the fluid quantity sensing method and apparatus of this invention is dependent upon an application of integrating sphere technology. An integrating sphere is a hollow structure which is coated with an optically-diffusing, highly reflective coating, or is otherwise provided with a highly radiant energy reflective interior surface. An incident beam of radiant energy which irradiates any portion of the interior surface of such sphere is integrated over the entire interior surface by virtue of multiple internal reflections. As a result, the interior surface of the sphere is completely illuminated with substantially uniform light energy, and a sensor positioned at any location within the sphere interior can accurately measure the energy per unit area of illumination.

However, vessels manufactured to contain fluid are not generally designed to act as integrating spheres, and even integrating spheres have localized optical phenomena that can affect the measurement of reflected light. To overcome this localized aberration, two or more sensors are employed and the results mathematically merged to form a more accurate representation of the amount of radiant energy absorbed by the fluid.

In the method of operation of this invention, the illuminating device is chosen to emit radiant energy at whatever wavelength has the best combination of absorption by the fluid within the vessel and spectral profile around the primary wavelength emitted. In turn, the vessel is preferably coated or otherwise provided with the capability of substantially reflecting radiant energy at such wavelength or wavelengths. Upon activation of the illuminating device, the interior surface of the vessel becomes illuminated with substantially uniform light energy in accordance with the integrating sphere theory described above. The fluid within the vessel, which may be particularly in zero gravity conditions, may be in contact with the vessel wall, free floating, or some combination thereof. In any event, the fluid absorbs some of the radiant energy in the course of passage therethrough, and the amount of energy absorbed is proportional to the amount of fluid in the vessel. As the amount of fluid present within the vessel decreases, a reduced amount of energy is absorbed and the more energy is sensed or measured by the photo-detector, and vice versa.

This absorption of radiant energy by the fluid is related to the absorption coefficient, or the measure of the rate of decrease of intensity of a beam of photons or particles in the course of passage through a particular substance or medium. When radiant energy enters a substance or medium, part of it is subjected to absorption and another part is scattered. The absorbed portion ceases to exist as radiation and is converted to other forms of energy such as heat, or is re-emitted as secondary radiation otherwise known as fluorescence.

Conventional methods of measuring the absorption coefficient for a particular fluid or other substance involve using a spectrophotometer. A spectrophotometer operates by directing a beam of monochromatic light through a sample contained in a curette, and then the intensity-reduced beam irradiates a photo detector positioned about 180 degrees from incident. The errors which can arise in this type of measurement of the absorption coefficient include reflection, convergence, spectral slit width, scattering, fluorescence, chemical reaction, and, inhomogeneity and anisotropy of the sample.

These types of errors in measurement of the absorption coefficient and localized reflective phenomena are substantially eliminated by the method and apparatus of this invention. As noted above, by employing a vessel which functions as an integrating sphere, the entire interior of the vessel is uniformly illuminated with radiant energy from a single beam of light. That portion of the radiant energy introduced into the vessel interior which is not absorbed by the fluid can be measured at multiple locations within the interior of the vessel. The positions of the photo-detectors are therefore completely independent of any fluid level and position of the fluid within the vessel, allowing an accurate energy measurement to be taken in zero gravity or any other conditions. Preferably, the illuminating device and photo-detectors are positioned relative to one another so as to avoid direct radiation of the detector by the illuminating device, or, alternatively, a barrier can be mounted within the vessel interior in position to physically block direct irradiation of the photo detector.

Therefore, the present invention succeeds in conferring the following, and other not mentioned, desirable and useful benefits and objectives.

It is an object of the present invention to provide an advance optical mass gauge sensor.

It is another object of the present invention to provide a more accurate and detector independent method of measuring fluid mass within a vessel.

Yet another object of the present invention is to provide a method of measuring fluid mass independent of gravitational influence.

Still another object of the present invention is to provide a method and apparatus for measuring fluid mass that overcomes irregularities and abnormalities in fluid vessel wall construction and coating.

Yet another object of the present invention is to provide a method and apparatus for measuring fluid mass by combining one or more radiant energy emitters with two or more radiant energy collectors to reduce manufacturing complexity, cost, and interference with fluid vessel components.

### BRIEF DESCRIPTION OF THE DRAWINGS

FIG. 1 is an elevational view, in cross section, of one embodiment of the apparatus of this invention.

FIG. 2 is an enlarged elevational view of one embodiment of a combined illuminating device and detector.

FIG. 3 depicts the devices of FIG. 2 as viewed from the outside of the vessel and is an enlarged cross sectional view.

FIG. 4 is an elevational view, in cross section, of an alternative embodiment herein.

### DETAILED DESCRIPTION OF THE PREFERRED EMBODIMENTS

Reference will now be made in detail to the preferred embodiments of the present invention. Such embodiments are provided by way of explanation of the present invention, which is not intended to be limited thereto. In fact, those of ordinary skill in the art may appreciate upon reading the present specification and viewing the present drawings that various modifications, substitutions, and variations can be made thereto. Therefore, it is the intention that this invention is not limited to the particular embodiments disclosed but rather the invention will include all embodiments within the scope of the appended claims.

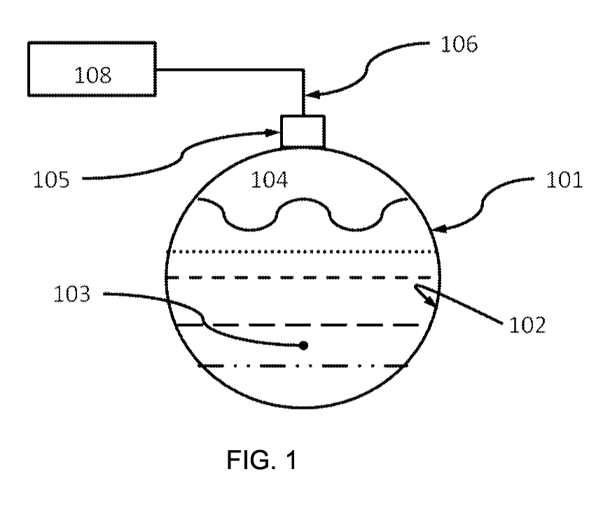

FIG. 1 is a side cross sectional view of a preferred embodiment of the present invention. Shown is a vessel 101, which is generally spherical shaped and has a hollow interior, 104. The vessel, 101, is preferentially a 12-inch interior diameter, Grade 5 (6% aluminum, 4% vanadium, with 0.25% maximum iron, 0.2% maximum oxygen, and the remainder titanium) “Minuteman” tank manufactured by ATK Space Systems, Inc. The interior surface, 102, is preferentially manufactured with a highly reflective Lambertian diffuse finish or coating that is capable of reflecting radiant energy at the wavelength or wavelengths that are absorbed at least partially by the enclosed fluid or fluids, 103. An illuminating device, 105, is attached to the wall of the vessel and emits radiant energy into the vessel interior, 104. The illuminating device, 105, includes one or more emitters of radiant energy, and two or more radiant energy collectors. The controller, 108, contains the source of the radiant energy, and is transmitted through optical fibers or wave guides, 106, to the illuminating device, 105. The controller, 108, in a laboratory setting, for measuring ethanol as an example, is preferentially a Thor Labs LDC4020 Benchtop Laser Diode Controller powering an Opto Diode Corporation OD-50L, 880 nm wavelength Super High-Power GaAlAs IR Emitter optically coupled to the illuminating device, 106, with 600 um borosilicate optical fibers manufactured by Fiberguide Industries. The controller, 108, controls the intensity and wavelength of the radiant energy and operates to turn the source of radiant energy on and off. The fluid, 103, is depicted in the liquid phase within the vessel, 101, under the influence of gravity.

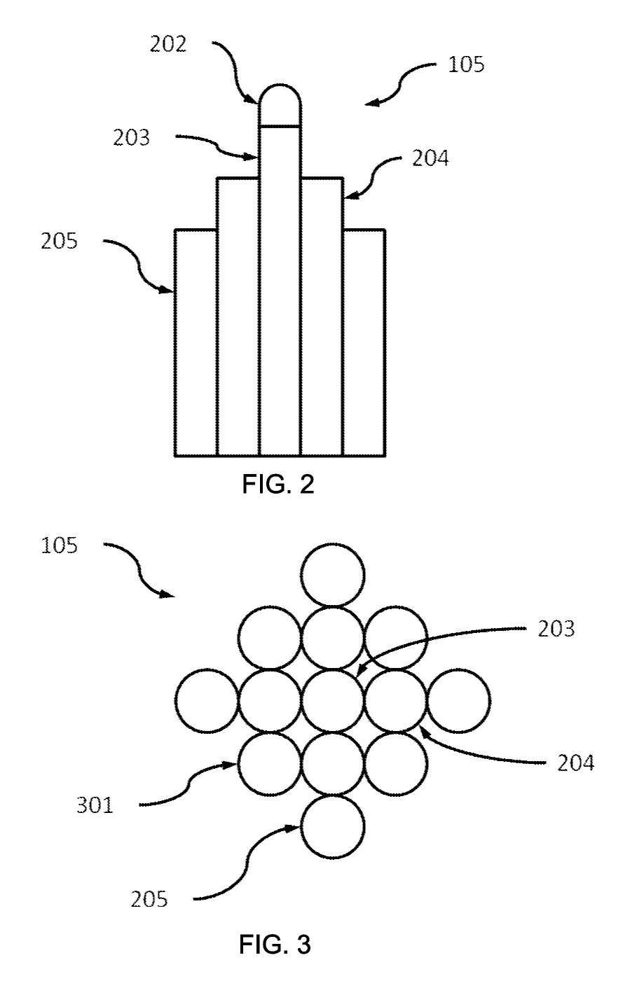

The illuminating device, 105, as shown in FIG. 2, is an enlarged elevational cross sectional view. An emitter, 203, includes a diffuser, 202, that is positioned such that radiant energy is not directed or reflected directly into the collectors, 204 and 205. The collector, 204, is directed to collect radiant energy directionally and radially separate from the emitter, 203 and diffuser, 204. Another collector, 205, is yet further directed directionally and radially away from the emitter, 203, and diffuser, 204, to collect radiant energy reflected from the interior surface, 102, of the vessel.

In FIG. 3, the illuminating device, 105, is an enlarged axial cross sectional view. An emitter, 203, is positioned centrally to the fiber optic or wave guide bundle. Radially, collectors are arranged and directed such that emitted radiant energy is not directed into or reflected directly into the collectors. The collectors, 204, 205, and 301, may alternately be emitters. In a preferred embodiment, for measuring ethanol for example, an array of Opto Diode Corporation ODD-45W or ODD-95W, 880 nm wavelength High-Sensitivity GaAlAs Photodiodes are optically coupled to the illuminating device, 106, with 600 um borosilicate optical fibers manufactured by Fiberguide Industries.

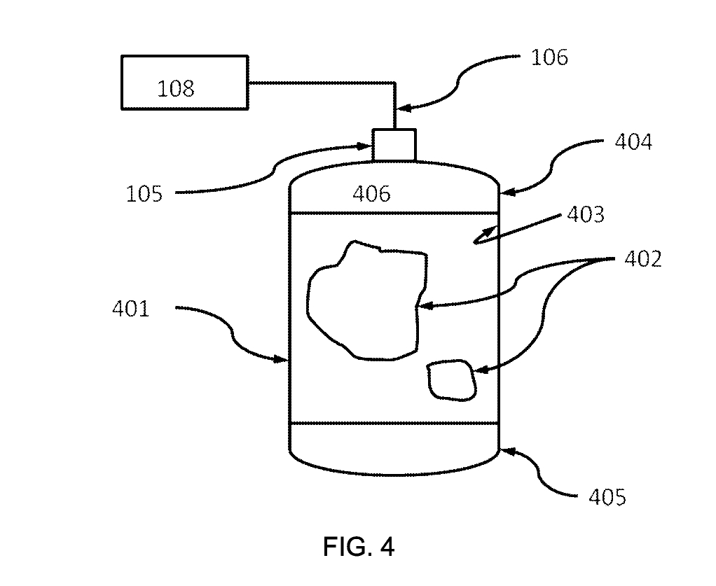

In another embodiment, as shown in FIG. 4, a cylindrical shaped tank, 401, is depicted. The opposite ends of the cylindrical shaped tank, 401, are closed with hemispherical end caps, 404, and 405, defining an interior space, 406. The interior surface, 403, is preferentially manufactured with a highly reflective Lambertian diffuse finish or coating that is capable of reflecting radiant energy at the wavelength or wavelengths that are absorbed at least partially by the enclosed fluid or fluids, 402. An illuminating device, 105, is attached to the wall of the vessel and emits radiant energy into the vessel interior, 406. The illuminating device, 105, includes one or more emitters of radiant energy, and two or more radiant energy collectors. The controller, 108, contains the source of the radiant energy, and is transmitted through optical fibers or wave guides, 106, to the illuminating device, 105. The controller, 108, controls the intensity and wavelength of the radiant energy and operates to turn the source of radiant energy on and off. The fluid, 402, is depicted in the liquid, solid, or gaseous phase within the vessel, 404, under zero or micro-gravity conditions.

In another embodiment, the vessel has a conical shape and is made of titanium, fiberglass and resins, plastics, metals, or other materials known in the art.

In yet another embodiment, the vessel has a multitude of geometric or random shapes.

In yet another embodiment, the controller and illuminating device are combined into a single unit, further reducing manufacturing and assembly complexity.

In preferred embodiments, the radiant energy source is a Light Emitting Diode or a laser. A hybrid, aspheric, or multi-lens optical component with or without diffusers shapes the radiant energy profile exiting the illuminating device.

What is claimed is:

1. An apparatus for sensing the quantity of a fluid which is capable of at least partially absorbing radiant energy having a particular wavelength, comprising:
a. a vessel having an interior whose surface diffuses and reflects radiant energy at said particular wavelength, said interior of said vessel containing said fluid;
b. an illuminating device for introducing radiant energy at said particular wavelength into said interior of said vessel; and
c. two or more detectors for measuring the energy per unit area of illumination created by the radiant energy within said interior of said vessel which is not absorbed by said fluid.

2. The apparatus of claim 1 in which said illuminating device is a light source mounted to said vessel in a position to introduce radiant energy into said interior of said vessel.

3. The apparatus of claim 2 in which said illuminating device further includes two or more detectors mounted to said vessel in proximity to said light source.

4. The apparatus of claim 1 in which said surface of said interior of said vessel is manufactured with a highly reflective Lambertian diffuse finish or coating that is capable of reflecting radiant energy at the wavelength or wavelengths that are absorbed at least partially by the enclosed fluid or fluids.

5. The apparatus of claim 1 in which said detector is a photo-detector.

6. The apparatus of claim 1 in which said fluid is a cryogenic liquid.

7. The apparatus of claim 1 in which said fluid is liquid natural gas.

8. The apparatus of claim 1 further including a barrier mounted within said interior of said illuminating device in position to substantially prevent the direct irradiation of said detector with radiant energy emitted from said illuminating device.

9. An apparatus for sensing the quantity of fluid contained within the interior of a vessel whose interior surface substantially reflects radiant energy of a particular wavelength which is at least partially absorbed by the fluid, comprising:
a. an illuminating device for introducing radiant energy at said particular wavelength into the interior of the vessel; and
b. a detector for measuring the energy per unit area of illumination created by the radiant energy within said interior of said vessel which is not absorbed by said fluid.

10. The apparatus of claim 9 in which said illuminating device is a light source mounted to said vessel in a position to introduce radiant energy into said interior of said vessel.

11. The apparatus of claim 10 in which said illuminating device further includes two or more detectors mounted to said vessel in proximity to said light source without being directly irradiated by said light source.

12. The apparatus of claim 9 in which said detector is a photo-detector.

13. The apparatus of claim 9 in which said fluid is a cryogenic liquid.

14. The apparatus of claim 9 in which said fluid is liquid natural gas.

15. An apparatus for sensing the quantity of at least a first fluid and a second fluid contained within the interior of a vessel whose interior surface is manufactured with a highly reflective Lambertian diffuse finish or coating that is capable of reflecting radiant energy having a first wavelength which is at least partially absorbed by the first fluid and a second wavelength which is at least partially absorbed by the second fluid, said apparatus comprising:
a. an illuminating device capable of introducing radiant energy containing the first wavelength and radiant energy containing the second wavelength into the interior of the vessel; and
b. a detector for measuring the energy per unit area of illumination attributable to the radiant energy at each of the first wavelength and said second wavelengths which is not absorbed by the first and second fluids, respectively.

16. The apparatus of claim 15 in which the first fluid is a gas and the second fluid is a liquid.

17. The apparatus of claim 15 in which each of the first and second fluids is a liquid.

18. The apparatus of claim 15 in which each of the first and second fluids is a gas.

19. A method of detecting the quantity of at least one fluid within the interior of a vessel, comprising:
a. introducing radiant energy into the interior of the vessel having a wavelength which is at least partially absorbed by the fluid therein, and which is at least partially reflected by the interior surface of the vessel;
b. detecting the radiant energy within the interior of the vessel which is not absorbed by the fluid; and
c. producing a signal having a component which is representative of a measurement of the energy per unit area of illumination created by the radiant energy not absorbed by the fluid.

20. The method of claim 19 in which step (a) comprises directing radiant energy from a light source communicating with the interior of the vessel.

21. The method of claim 19 in which step (b) comprises sensing radiant energy within the interior of the vessel with a photo-detector communicating with the interior of the vessel.

22. The method of claim 19 in which step (a) comprises directing radiant energy into the interior of the vessel having a first wavelength which is at least partially absorbed by a first fluid within the vessel, and directing radiant energy into the interior of the vessel having a second wavelength which is at least partially absorbed by a second fluid within the vessel.
